(19) United States
(12) Patent Application Publication
(10) Pub. No.: US 2009/0131268 A1
(43) Pub. Date: May 21, 2009

(54) Methods for Genotyping Polymorphisms

(75) Inventors: Paul Hardenbol, San Francisco, CA (US); Jonathan E. Forman, San Carlos, CA (US); George Karlin-Neumann, Palo Alto, CA (US); Xin Miao, Menlo Park, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, Inc., Santa Clara, CA (US)

(21) Appl. No.: 12/211,103

(22) Filed: Sep. 15, 2008

Related U.S. Application Data
(60) Provisional application No. 60/972,548, filed on Sep. 14, 2007.

(51) Int. Cl. C40B 30/04

(52) U.S. Cl. 506/9

(57) ABSTRACT

The invention provides method for genotyping specific sets of polymorphisms in a single multiplex reaction. The polymorphisms are selected to be of interest in detecting genetic variation that alters individuals' metabolism, distribution, extretion and transport of pharmacological compounds. In preferred aspects the genotyping employs a multiplex hybridization-based assay. In some aspects combinations of methods are employed to allow the combination of polymorphisms to be interrogated. The invention also provides nucleic acid standards for validating the performance of such hybridization-based assays.

### RELATED APPLICATIONS

This application claims priority to U.S. Provisional Application No. 60/972,548 filed Sep. 14, 2007, the entire disclosure of which is incorporated herein by reference.

### FIELD OF THE INVENTION

The present invention relates to methods and compositions for predicting drug responses.

### BACKGROUND OF THE INVENTION

Single nucleotide polymorphisms (SNPs) have emerged as the marker of choice for genome wide association studies and genetic linkage studies. Building SNP maps of the genome will provide the framework for new studies to identify the underlying genetic basis of complex diseases such as cancer, mental illness and diabetes. Due to the wide ranging applications of SNPs there is still a need for the development of robust, flexible, cost-effective technology platforms that allow for scoring genotypes in large numbers of samples.

Many high throughput approaches for analyzing genetic processes and variation make use of complex mixtures of oligonucleotides to detect, sort, or manipulate gene products and/or genomic fragments, e.g. Brenner et al, Proc. Natl. Acad. Sci., 97: 1665-1670 (2000); Church et al, Science, 240: 185-188 (1988); Chee et al, Science, 274: 610-614 (1996); Shoemaker et al, Nature Genetics, 14: 450-456 (1996); Hardenbol et al, Nature Biotechnology, 21: 673-678 (2003); Kennedy et al, Nature Biotechnology, 21: 1233-1237 (2003); and the like. Such techniques are starting to be employed to genotype individuals to determine susceptibilities to a variety of conditions, including cancer, adverse drug reactions, responsiveness to targeted therapeutics, and the like, particularly in clinical trial settings. As these complex hybridization-based techniques move out of research laboratories and into medical and diagnostic applications, there will be a critical need to ensure that readouts based on the techniques are robust and valid, e.g. Food and Drug Administration, “Class II special controls guidance document: Instrumentation for clinical multiplex test systems,” Guidance for Industry and FDA Staff (Mar. 10, 2005).

When polymorphisms are closely spaced along a gene or genome, certain polymorphisms, particularly insertions or deletions, at one locus may interfere with the detection of a polymorphism at adjacent loci in hybridization-based assays because of anomalous hybridization and/or interference among probes. This situation makes it difficult to determine whether a lack of signal in a readout is due to the absence of a polymorphism, probe degradation, probe interference, or other problems, e.g. Landi et al, BioTechniques, 35: 816-827 (2003). The difficulty of such determinations is exacerbated when highly complex probes are used that comprise hundreds, or even thousands, of hybridizing components.

Such difficulties may be crucial when hybridization-based assays are used to genotype a large set of xenobiotic metabolizing genes to determine an effective dosage of a drug for a patient. Metabolism of xenobiotic substances, such as drugs, is a chemical process, by which the body structurally modifies foreign compounds to enhance their solubility and facilitate their excretion. This involves two distinct metabolic phases: enzymatic oxidation, reduction, and hydrolysis reactions, which expose or add functional groups to produce polar molecules (Phase I metabolism) and addition of endogenous compounds to the molecules to further increase polarity (Phase II metabolism). The bulk of responsibility for the Phase I reactions rests on the cytochrome P450 (CYP450) superfamily of enzymes. The CYP450 family consists of 60 to 100 different monoxygenases that catalyze the oxidative metabolism of lipophilic chemicals. These, together with several members of different families of transport proteins, play a crucial role in the disposition and elimination of a diverse array of therapeutic drugs and other xenobiotics. It is now well established that significant inter-individual variability exists in patient drug disposition and response. Much of the observed heterogeneity is thought to be due to the underlying genetic variation in the human population. Individual differences at a single nucleotide of DNA, otherwise known as single nucleotide polymorphisms (SNPs), are the most abundant source of genetic variation in humans. Many SNPs with potential for altering the activity of proteins involved in drug metabolism, such as the CYP450s have been found, e.g. Daly, Fundamental & Clinical Pharmacology, 17: 27-41 (2003). Phenotypes resulting from these genetic changes can markedly influence a drugs pharmacokinetics or change its efficacy and/or toxicity profile. Several examples exist where subjects carrying certain alleles suffer from a lack of drug efficacy, due to ultrarapid metabolism (UM) or, alternatively, adverse effects from the drug treatment due to impaired drug clearance by poor metabolism (PM). In current clinical practice, the suitability of a drug for a given individual is determined by trial and error. This practice places a significant burden on healthcare systems and costs. Having an accurate genetic profile of a patient's drug metabolizing genes would help ensure that the patient receives the most effective treatment, while avoiding inadvertent adverse drug reactions in poor metabolizers.

More than 3 billion prescriptions are written each year in the U.S. alone, effectively preventing or treating illness in hundreds of millions of people. But prescription medications also can cause powerful toxic effects in a patient. These effects are called adverse drug reactions (ADR). Adverse drug reactions can cause serious injury and or even death. Differences in the ways in which individuals utilize and eliminate drugs from their bodies are one of the most important causes of ADRs. Differences in metabolism also cause doses of drugs to be less effective than desired in some individuals.

A study performed in 1998 found that in the United States in the year 1994, more than 106,000 hospital patient deaths were attributed to serious adverse drug reactions or events (ADRs or ADEs) and an additional 2.2 million hospitalized patients had serious ADRs (Lazarou J, et al. JAMA 1998; 279:1200-5). Current estimates are that more than 200,000 Americans dies each year as a result of ADRs making ADRs one of the top 10 causes of death for Americans. Approximately seven percent of all hospital patients were affected by serious or fatal ADRs. ADRs are a severe, common and growing cause of death, disability and resource consumption.

It is estimated that drug-related anomalies account for nearly 10 percent of all hospital admissions. Drug-related morbidity and mortality in the U.S. is estimated to cost the U.S. health care system 177 billion in 2000, representing approximately 10% of total U.S. health care spending (Ernst and Grizzle, J Am Pharm Assoc 41(2):192-199, 2001.

Most prescription drugs are currently prescribed at standard doses in a “one size fits all” method. This “one size fits all” method, however, does not consider important genetic differences that give different individuals dramatically different abilities to metabolize and derive benefit from a particular drug. Improved methods for predicting an individual's response to a given drug or a particular dosage of a drug are needed.

### SUMMARY OF THE INVENTION

Methods for designing probes to optimize probe performance by taking into account local effects of the target sequence are disclosed. Local features that may be taken into consideration in probe design include insertions, deletions, secondary or interfering mutations, sequences immediately up or downstream of a variant to be detected, and sequence of complementary strands. For each target sequence a probe may be designed that is optimized for that sequence. Panels of probes may be combined that have different characteristics.

Specific collections of SNPs are disclosed. The SNPs have been selected for inclusion based on a variety of factors including frequency, presence in a gene reported in the literature to be involved in drug metabolism, excretion, transport, and distribution.

### BRIEF DESCRIPTION OF THE FIGURES

FIG. 1A shows the orientation of the probe 101 and the target 102

FIG. 1B shows a schematic of an embodiment that uses allele specific molecular inversion probes.

FIG. 2 shows one embodiment of inversion and amplification of a molecular inversion probe.

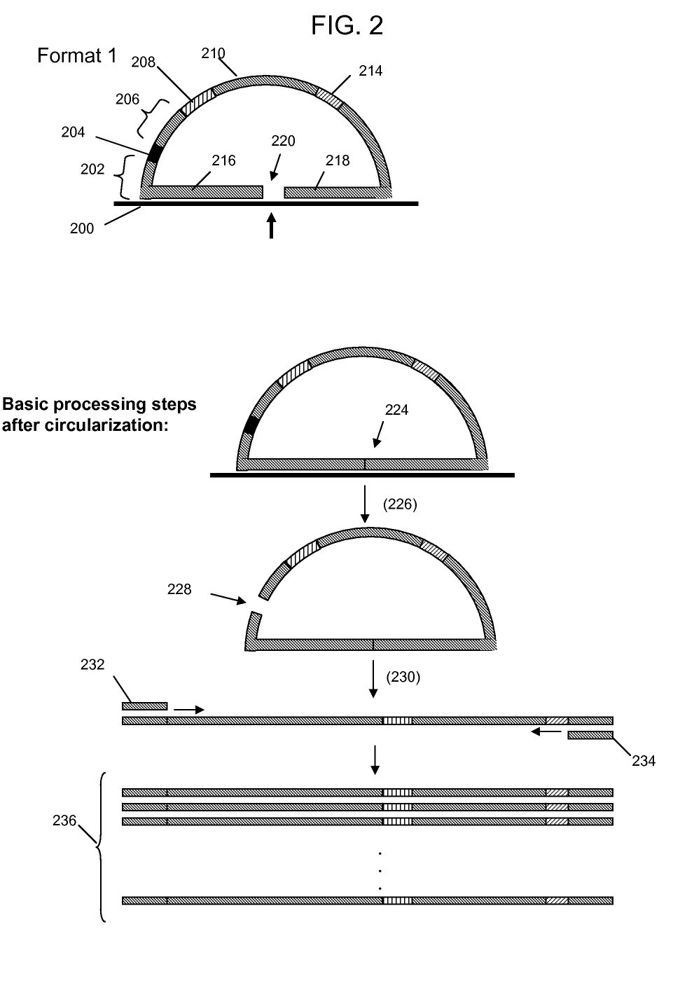

FIG. 3 shows a schematic for detection of an indel using molecular inversion probe technology. FIG. 3A shows the insertion allele and the deletion allele. 3B. shows probe design and 3C shows the possible outcomes for each probe and associated calls.

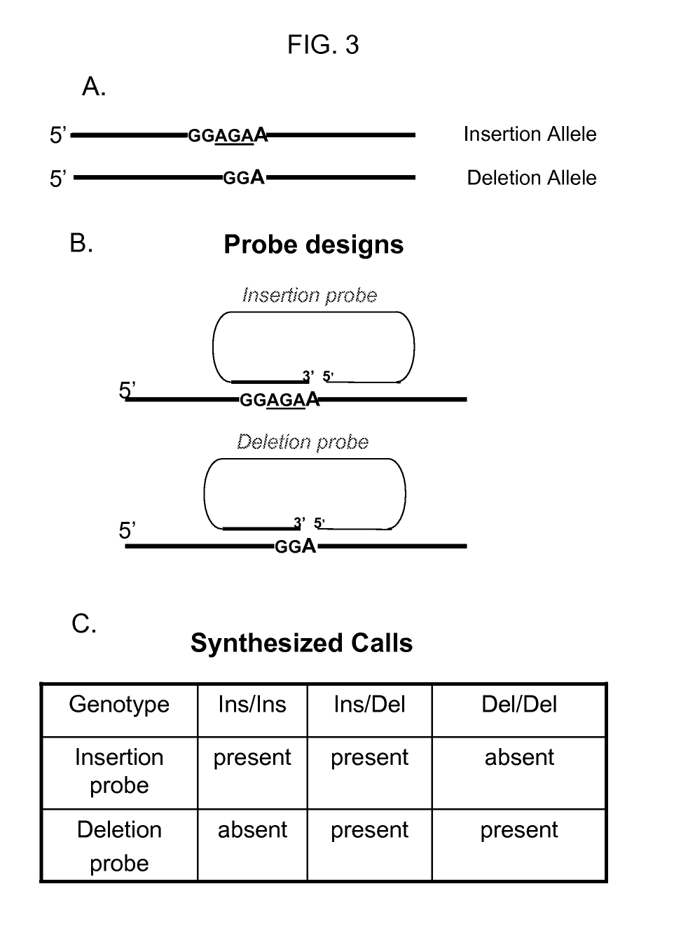

FIG. 4 shows two adjacent loci that are interfering.

### DETAILED DESCRIPTION OF THE INVENTION

### a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip™. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, for example, PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (for example, Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), 09/910,292 (U.S. Patent Application Publication 20030082543), and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y, 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication Number 20020183936), 10/065,856, 10/065,868, 10/328,818, 10/328,872, 10/423,403, and 60/482,389.

### b) Definitions

“Addressable” in reference to tag complements means that the nucleotide sequence, or perhaps other physical or chemical characteristics, of an end-attached probe, such as a tag complement, can be determined from its address, i.e. a one-to-one correspondence between the sequence or other property of the end-attached probe and a spatial location on, or characteristic of, the solid phase support to which it is attached. Preferably, an address of a tag complement is a spatial location, e.g. the planar coordinates of a particular region containing copies of the end-attached probe. However, end-attached probes may be addressed in other ways too, e.g. by microparticle size, shape, color, frequency of micro-transponder, or the like, e.g. Chandler et al, PCT publication WO 97/14028.

The term “allele’ as used herein is any one of a number of alternative forms a given locus (position) on a chromosome. An allele may be used to indicate one form of a polymorphism, for example, a biallelic SNP may have possible alleles A and B. An allele may also be used to indicate a particular combination of alleles of two or more SNPs in a given gene or chromosomal segment. The frequency of an allele in a population is the number of times that specific allele appears divided by the total number of alleles of that locus.

“Amplicon” means the product of a polynucleotide amplification reaction. That is, it is a population of polynucleotides, usually double stranded, that are replicated from one or more starting sequences. The one or more starting sequences may be one or more copies of the same sequence, or it may be a mixture of different sequences. Amplicons may be produced by a variety of amplification reactions whose products are multiple replicates of one or more target nucleic acids. Generally, amplification reactions producing amplicons are “template-driven” in that base pairing of reactants, either nucleotides or oligonucleotides, have complements in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. Pat. Nos. 4,683,195; 4,965,188; 4,683,202; 4,800,159 (PCR); Gelfand et al, U.S. Pat. No. 5,210,015 (real-time PCR with “taqman” probes); Wittwer et al, U.S. Pat. No. 6,174,670; Kacian et al, U.S. Pat. No. 5,399,491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. An amplification reaction may be a “real-time” amplification if a detection chemistry is available that permits a reaction product to be measured as the amplification reaction progresses, e.g. “real-time PCR” described below, or “real-time NASBA” as described in Leone et al, Nucleic Acids Research, 26: 2150-2155 (1998), and like references. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like.

“Complementary or substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference. [0016] “Duplex” means at least two oligonucleotides and/or polynucleotides that are fully or partially complementary undergo Watson-Crick type base pairing among all or most of their nucleotides so that a stable complex is formed. The terms “annealing” and “hybridization” are used interchangeably to mean the formation of a stable duplex. In one aspect, stable duplex means that a duplex structure is not destroyed by a stringent wash, e.g. conditions including temperature of about 5.degree. C. less that the T.sub.m of a strand of the duplex and low monovalent salt concentration, e.g. less than 0.2 M, or less than 0.1 M. “Perfectly matched” in reference to a duplex means that the poly- or oligonucleotide strands making up the duplex form a double stranded structure with one another such that every nucleotide in each strand undergoes Watson-Crick basepairing with a nucleotide in the other strand. The term “duplex” comprehends the pairing of nucleoside analogs, such as deoxyinosine, nucleosides with 2-aminopurine bases, PNAs, and the like, that may be employed. A “mismatch” in a duplex between two oligonucleotides or polynucleotides means that a pair of nucleotides in the duplex fails to undergo Watson-Crick bonding.

“Genetic locus,” or “locus” in reference to a genome or target polynucleotide, means a contiguous subregion or segment of the genome or target polynucleotide. As used herein, genetic locus, or locus, may refer to the position of a nucleotide, a gene, or a portion of a gene in a genome, including mitochondrial DNA, or it may refer to any contiguous portion of genomic sequence whether or not it is within, or associated with, a gene. In one aspect, a genetic locus refers to any portion of genomic sequence, including mitochondrial DNA, from a single nucleotide to a segment of few hundred nucleotides, e.g. 100-300, in length. Usually, a particular genetic locus may be identified by its nucleotide sequence, or the nucleotide sequence, or sequences, of one or both adjacent or flanking regions.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “genotype” as used herein refers to the genetic information an individual carries at one or more positions in the genome. A genotype may refer to the information present at a single polymorphism, for example, a single SNP. For example, if a SNP is biallelic and can be either an A or a C then if an individual is homozygous for A at that position the genotype of the SNP is homozygous A or AA. Genotype may also refer to the information present at a plurality of polymorphic positions.

The term “Hardy-Weinberg equilibrium” (HWE) as used herein refers to the principle that an allele that when homozygous leads to a disorder that prevents the individual from reproducing does not disappear from the population but remains present in a population in the undetectable heterozygous state at a constant allele frequency.

“Hybridization” refers to the process in which two single-stranded polynucleotides bind non-covalently to form a stable double-stranded polynucleotide. The term “hybridization” may also refer to triple-stranded hybridization. The resulting (usually) double-stranded polynucleotide is a “hybrid” or “duplex.” “Hybridization conditions” will typically include salt concentrations of less than about 1M, more usually less than about 500 mM and less than about 200 mM. Hybridization temperatures can be as low as 5.degree. C., but are typically greater than 22.degree. C., more typically greater than about 30.degree. C., and preferably in excess of about 37.degree. C. Hybridizations are usually performed under stringent conditions, i.e. conditions under which a probe will hybridize to its target subsequence. Stringent conditions are sequence-dependent and are different in different circumstances. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone. Generally, stringent conditions are selected to be about 5.degree. C. lower than the T.sub.m for the specific sequence at s defined ionic strength and pH. Exemplary stringent conditions include salt concentration of at least 0.01 M to no more than 1 M Na ion concentration (or other salts) at a pH 7.0 to 8.3 and a temperature of at least 25.degree. C. For example, conditions of 5.times.SSPE (750 mM NaCl, 50 mM NaPhosphate, 5 mM EDTA, pH 7.4) and a temperature of 25-30.degree. C. are suitable for allele-specific probe hybridizations. For stringent conditions, see for example, Sambrook, Fritsche and Maniatis. “Molecular Cloning A laboratory Manual” 2.sup.nd Ed. Cold Spring Harbor Press (1989) and Anderson “Nucleic Acid Hybridization” 1.sup.st Ed., BIOS Scientific Publishers Limited (1999), which are hereby incorporated by reference in its entirety for all purposes above. “Hybridizing specifically to” or “specifically hybridizing to” or like expressions refer to the binding, duplexing, or hybridizing of a molecule substantially to or only to a particular nucleotide sequence or sequences under stringent conditions when that sequence is present in a complex mixture (e.g., total cellular) DNA or RNA.

“Hybridization-based assay” means any assay that relies on the formation of a stable duplex or triplex between a probe and a target nucleotide sequence for detecting or measuring such a sequence. In one aspect, probes of such assays anneal to (or form duplexes with) regions of target sequences in the range of from 8 to 100 nucleotides; or in other aspects, they anneal to target sequences in the range of from 8 to 40 nucleotides, or more usually, in the range of from 8 to 20 nucleotides. A “probe” in reference to a hybridization-based assay mean a polynucleotide that has a sequence that is capable of forming a stable hybrid (or triplex) with its complement in a target nucleic acid and that is capable of being detected, either directly or indirectly. Hybridization-based assays include, without limitation, assays based on use of oligonucleotides, such as polymerase chain reactions, NASBA reactions, oligonucleotide ligation reactions, single-base extensions of primers, circularizable probe reactions, allele-specific oligonucleotides hybridizations, either in solution phase or bound to solid phase supports, such as microarrays or microbeads. There is extensive guidance in the literature on hybridization-based assays, e.g. Hames et al, editors, Nucleic Acid Hybridization a Practical Approach (IRL Press, Oxford, 1985); Tijssen, Hybridization with Nucleic Acid Probes, Parts I & II (Elsevier Publishing Company, 1993); Hardiman, Microarray Methods and Applications (DNA Press, 2003); Schena, editor, DNA Microarrays a Practical Approach (IRL Press, Oxford, 1999); and the like. In one aspect, hybridization-based assays are solution phase assays; that is, both probes and target sequences hybridize under conditions that are substantially free of surface effects or influences on reaction rate. A solution phase assay may include circumstance where either probes or target sequences are attached to microbeads.

“Interfering polymorphic loci” mean closely spaced loci having sequence variants, or alleles, usually insertions, detections, or substitutions, that are sought to be determined by a hybridization-based assay. In one aspect, interfering polymorphic loci are a pair of closely spaced loci in which at least one locus of the pair contains two or more alternative forms, each having a characteristic sequence, such that the presence of at least one characteristic sequence destabilizes a probe specific for the other locus of the pair on the same DNA strand. Characteristic sequences of alleles may be identified in conventional databases, e.g. dbSNP, or the like. The region of a target polynucleotide or genome that interfering polymorphic loci span depends in part on the nature of the probes employed in a hybridization-based assay. Thus, in one aspect, members of a pair of interfering polymorphic loci are within 40 nucleotides of one another; or in another aspect such members may be within 20 nucleotides of one another.

“Kit” refers to any delivery system for delivering materials or reagents for carrying out a method of the invention. In the context of assays, such delivery systems include systems that allow for the storage, transport, or delivery of reaction reagents (e.g., probes, enzymes, etc. in the appropriate containers) and/or supporting materials (e.g., buffers, written instructions for performing the assay etc.) from one location to another. For example, kits include one or more enclosures (e.g., boxes) containing the relevant reaction reagents and/or supporting materials for assays of the invention. In one aspect, kits of the invention comprise probes specific for interfering polymorphic loci. In another aspect, kits comprise nucleic acid standards for validating the performance of probes specific for interfering polymorphic loci. Such contents may be delivered to the intended recipient together or separately. For example, a first container may contain an enzyme for use in an assay, while a second container contains probes.

“Ligation” means to form a covalent bond or linkage between the termini of two or more nucleic acids, e.g. oligonucleotides and/or polynucleotides, in a template-driven reaction. The nature of the bond or linkage may vary widely and the ligation may be carried out enzymatically or chemically. As used herein, ligations are usually carried out enzymatically to form a phosphodiester linkage between a 5′ carbon of a terminal nucleotide of one oligonucleotide with 3′ carbon of another oligonucleotide. A variety of template-driven ligation reactions are described in the following references, which are incorporated by reference: Whitely et al, U.S. Pat. No. 4,883,750; Letsinger et al, U.S. Pat. No. 5,476,930; Fung et al, U.S. Pat. No. 5,593,826; Kool, U.S. Pat. No. 5,426,180; Landegren et al, U.S. Pat. No. 5,871,921; Xu and Kool, Nucleic Acids Research, 27: 875-881 (1999); Higgins et al, Methods in Enzymology, 68: 50-71 (1979); Engler et al, The Enzymes, 15: 3-29 (1982); and Namsaraev, U.S. patent publication 2004/0110213.

The term “linkage analysis” as used herein refers to a method of genetic analysis in which data are collected from affected families, and regions of the genome are identified that co-segregated with the disease in many independent families or over many generations of an extended pedigree. A disease locus may be identified because it lies in a region of the genome that is shared by all affected members of a pedigree. Methods of performing linkage analysis are disclosed, for example, in Sellick et al, Diabetes 52:2636-38 (2003), Sellick et al., Nucleic Acids Res., 32:e164 (2004), and Janecke et al., Nat. Genet., 36:850-4 (2004).

The term “linkage disequilibrium” or sometimes referred to as “allelic association” as used herein refers to the preferential association of a particular allele or genetic marker with a specific allele, or genetic marker at a nearby chromosomal location more frequently than expected by chance for any particular allele frequency in the population. For example, if locus X has alleles A and B, which occur equally frequently, and linked locus Y has alleles C and D, which occur equally frequently, one would expect the combination AC to occur with a frequency of 0.25. If AC occurs more frequently, then alleles A and C are in linkage disequilibrium. Linkage disequilibrium may result from natural selection of certain combination of alleles or because an allele has been introduced into a population too recently to have reached equilibrium with linked alleles. The genetic interval around a disease locus may be narrowed by detecting disequilibrium between nearby markers and the disease locus. For additional information on linkage disequilibrium see Ardlie et al, Nat. Rev. Gen. 3:299-309, 2002. Methods of performing genome wide association studies are disclosed, for example, in Hu et al., Cancer Res. 65:2542-6 (2005), Mitra et al., Cancer Res. 64:8116-25 (2004), Klein et al., Science 308:385-9 (2005) and Godde et al., J. Mol. Med. 83:486-94 (2005).

“Microarray” or “array” refers to a solid phase support having a planar surface, which carries an array of nucleic acids, each member of the array comprising identical copies of an oligonucleotide or polynucleotide immobilized to a spatially defined region or site, which does not overlap with those of other members of the array; that is, the regions or sites are spatially discrete. Spatially defined hybridization sites may additionally be “addressable” in that its location and the identity of its immobilized oligonucleotide are known or predetermined, for example, prior to its use. Typically, the oligonucleotides or polynucleotides are single stranded and are covalently attached to the solid phase support, usually by a 5′-end or a 3′-end. The density of non-overlapping regions containing nucleic acids in a microarray is typically greater than 100 per cm.sup.2, and more preferably, greater than 1000 per cm.sup.2. Microarray technology is reviewed in the following references: Schena, Editor, Microarrays: A Practical Approach (IRL Press, Oxford, 2000); Southern, Current Opin. Chem. Biol., 2: 404-410 (1998); Nature Genetics Supplement, 21: 1-60 (1999). As used herein, “random microarray” refers to a microarray whose spatially discrete regions of oligonucleotides or polynucleotides are not spatially addressed. That is, the identity of the attached oligonucleoties or polynucleotides is not discernable, at least initially, from its location. In one aspect, random microarrays are planar arrays of microbeads wherein each microbead has attached a single kind of hybridization tag complement, such as from a minimally cross-hybridizing set of oligonucleotides. Arrays of microbeads may be formed in a variety of ways, e.g. Brenner et al, Nature Biotechnology, 18: 630-634 (2000); Tulley et al, U.S. Pat. No. 6,133,043; Stuelpnagel et al, U.S. Pat. No. 6,396,995; Chee et al, U.S. Pat. No. 6,544,732; and the like. Likewise, after formation, microbeads, or oligonucleotides thereof, in a random array may be identified in a variety of ways, including by optical labels, e.g. fluorescent dye ratios or quantum dots, shape, sequence analysis, or the like. The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

“Nucleoside” as used herein includes the natural nucleosides, including 2′-deoxy and 2′-hydroxyl forms, e.g. as described in Kornberg and Baker, DNA Replication, 2nd Ed. (Freeman, San Francisco, 1992). “Analogs” in reference to nucleosides includes synthetic nucleosides having modified base moieties and/or modified sugar moieties, e.g. described by Scheit, Nucleotide Analogs (John Wiley, New York, 1980); Uhlman and Peyman, Chemical Reviews, 90: 543-584 (1990), or the like, with the proviso that they are capable of specific hybridization. Such analogs include synthetic nucleosides designed to enhance binding properties, reduce complexity, increase specificity, and the like. Polynucleotides comprising analogs with enhanced hybridization or nuclease resistance properties are described in Uhlman and Peyman (cited above); Crooke et al, Exp. Opin. Ther. Patents, 6: 855-870 (1996); Mesmaeker et al, Current Opinion in Structural Biology, 5: 343-355 (1995); and the like. Exemplary types of polynucleotides that are capable of enhancing duplex stability include oligonucleotide N3′.fwdarw.P5′ phosphoramidates (referred to herein as “amidates”), peptide nucleic acids (referred to herein as “PNAs”), oligo-2′-O-alkylribonucleotides, polynucleotides containing C-5 propynylpyrimidines, locked nucleic acids (LNAs), and like compounds. Such oligonucleotides are either available commercially or may be synthesized using methods described in the literature.

The term “oligonucleotide” or sometimes refer by “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

Pharmacogenomics is the study of the relationship between an individual's genotype and that individual's response to a foreign compound or drug. Differences in metabolism of therapeutics can lead to severe toxicity or therapeutic failure by altering the relation between dose and blood concentration of the pharmacologically active drug. Thus, a physician or clinician may consider applying knowledge obtained in relevant pharmacogenomics studies in determining the type of drug and dosage and/or therapeutic regimen of treatment.

Pharmacogenomics deals with clinically significant hereditary variations in the response to drugs due to altered drug disposition and abnormal action in affected persons. See, for example, Eichelbaum, M. et al. (1996) Clin. Exp. Pharmacol. Physiol. 23(1-11):983-985 and Linder, M. W. et al. (1997) Clin. Chem. 43(2):254-266. In general, two types of pharmacogenetic conditions can be differentiated. Genetic conditions transmitted as a single factor altering the way drugs act on the body (altered drug action) or genetic conditions transmitted as single factors altering the way the body acts on drugs (altered drug metabolism). These pharmacogenetic conditions can occur either as rare genetic defects or as naturally-occurring polymorphisms. For example, glucose-6-phosphate dehydrogenase deficiency (G6PD) is a common inherited enzymopathy in which the main clinical complication is haemolysis after ingestion of oxidant drugs (anti-malarials, sulfonamides, analgesics, nitrofarans) and consumption of fava beans. Thus, it would be highly desirable to dispose of fast and cheap methods for determining a subject's genotype so as to predict the best treatment.

“Polymerase chain reaction,” or “PCR,” means a reaction for the in vitro amplification of specific DNA sequences by the simultaneous primer extension of complementary strands of DNA. In other words, PCR is a reaction for making multiple copies or replicates of a target nucleic acid flanked by primer binding sites, such reaction comprising one or more repetitions of the following steps: (i) denaturing the target nucleic acid, (ii) annealing primers to the primer binding sites, and (iii) extending the primers by a nucleic acid polymerase in the presence of nucleoside triphosphates. Usually, the reaction is cycled through different temperatures optimized for each step in a thermal cycler instrument. Particular temperatures, durations at each step, and rates of change between steps depend on many factors well-known to those of ordinary skill in the art, e.g. exemplified by the references: McPherson et al, editors, PCR: A Practical Approach and PCR2: A Practical Approach (IRL Press, Oxford, 1991 and 1995, respectively). For example, in a conventional PCR using Taq DNA polymerase, a double stranded target nucleic acid may be denatured at a temperature >90.degree. C., primers annealed at a temperature in the range 50-75.degree. C., and primers extended at a temperature in the range 72-78.degree. C. The term “PCR” encompasses derivative forms of the reaction, including but not limited to, RT-PCR, real-time PCR, nested PCR, quantitative PCR, multiplexed PCR, and the like. Reaction volumes range from a few hundred nanoliters, e.g. 200 mL, to a few hundred .mu.L, e.g. 200 .mu.L. “Reverse transcription PCR,” or “RT-PCR,” means a PCR that is preceded by a reverse transcription reaction that converts a target RNA to a complementary single stranded DNA, which is then amplified, e.g. Tecott et al, U.S. Pat. No. 5,168,038, which patent is incorporated herein by reference. “Real-time PCR” means a PCR for which the amount of reaction product, i.e. amplicon, is monitored as the reaction proceeds. There are many forms of real-time PCR that differ mainly in the detection chemistries used for monitoring the reaction product, e.g. Gelfand et al, U.S. Pat. No. 5,210,015 (“taqman”); Wittwer et al, U.S. Pat. Nos. 6,174,670 and 6,569,627 (intercalating dyes); Tyagi et al, U.S. Pat. No. 5,925,517 (molecular beacons); which patents are incorporated herein by reference. Detection chemistries for real-time PCR are reviewed in Mackay et al, Nucleic Acids Research, 30: 1292-1305 (2002), which is also incorporated herein by reference. “Nested PCR” means a two-stage PCR wherein the amplicon of a first PCR becomes the sample for a second PCR using a new set of primers, at least one of which binds to an interior location of the first amplicon. As used herein, “initial primers” in reference to a nested amplification reaction mean the primers used to generate a first amplicon, and “secondary primers” mean the one or more primers used to generate a second, or nested, amplicon. “Multiplexed PCR” means a PCR wherein multiple target sequences (or a single target sequence and one or more reference sequences) are simultaneously carried out in the same reaction mixture, e.g. Bernard et al, Anal. Biochem., 273: 221-228 (1999) (two-color real-time PCR). Usually, distinct sets of primers are employed for each sequence being amplified. “Quantitative PCR” means a PCR designed to measure the abundance of one or more specific target sequences in a sample or specimen. Quantitative PCR includes both absolute quantitation and relative quantitation of such target sequences. Quantitative measurements are made using one or more reference sequences that may be assayed separately or together with a target sequence. The reference sequence may be endogenous or exogenous to a sample or specimen, and in the latter case, may comprise one or more competitor templates. Typical endogenous reference sequences include segments of transcripts of the following genes: .beta.-actin, GAPDH, .beta.sub.2-microglobulin, ribosomal RNA, and the like. Techniques for quantitative PCR are well-known to those of ordinary skill in the art, as exemplified in the following references that are incorporated by reference: Freeman et al, Biotechniques, 26: 112-126 (1999); Becker-Andre et al, Nucleic Acids Research, 17: 9437-9447 (1989); Zimmerman et al, Biotechniques, 21: 268-279 (1996); Diviacco et al, Gene, 122: 3013-3020 (1992); Becker-Andre et al, Nucleic Acids Research, 17: 9437-9446 (1989); and the like.

“Polymorphism” or “genetic variant” means a substitution, inversion, insertion, or deletion of one or more nucleotides at a genetic locus, or a translocation of DNA from one genetic locus to another genetic locus. In one aspect, polymorphism means one of multiple alternative nucleotide sequences that may be present at a genetic locus of an individual and that may comprise a nucleotide substitution, insertion, or deletion with respect to other sequences at the same locus in the same individual, or other individuals within a population. An individual may be homozygous or heterozygous at a genetic locus; that is, an individual may have the same nucleotide sequence in both alleles, or have a different nucleotide sequence in each allele, respectively. In one aspect, insertions or deletions at a genetic locus comprises the addition or the absence of from 1 to 10 nucleotides at such locus, in comparison with the same locus in another individual of a population (or another allele in the same individual). Usually, insertions or deletions are with respect to a major allele at a locus within a population, e.g. an allele present in a population at a frequency of fifty percent or greater.

“Polynucleotide” or “oligonucleotide” are used interchangeably and each mean a linear polymer of nucleotide monomers. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, or the like. Such monomers and their internucleosidic linkages may be naturally occurring or may be analogs thereof, e.g. naturally occurring or non-naturally occurring analogs. Non-naturally occurring analogs may include PNAs, phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moities, or bases at any or some positions. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′.fwdarw.3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process are determined by the sequence of the template polynucleotide. Usually primers are extended by a DNA polymerase. Primers usually have a length in the range of from 14 to 36 nucleotides.

“Readout” means a parameter, or parameters, which are measured and/or detected that can be converted to a number or value. In some contexts, readout may refer to an actual numerical representation of such collected or recorded data. For example, a readout of fluorescent intensity signals from a microarray is the address and fluorescence intensity of a signal being generated at each hybridization site of the microarray; thus, such a readout may be registered or stored in various ways, for example, as an image of the microarray, as a table of numbers, or the like.

“Sample” means a quantity of material from a biological, environmental, medical, or patient source in which detection or measurement of target nucleic acids is sought. On the one hand it is meant to include a specimen or culture (e.g., microbiological cultures). On the other hand, it is meant to include both biological and environmental samples. A sample may include a specimen of synthetic origin. Biological samples may be animal, including human, fluid, solid (e.g., stool) or tissue, as well as liquid and solid food and feed products and ingredients such as dairy items, vegetables, meat and meat by-products, and waste. Biological samples may include materials taken from a patient including, but not limited to cultures, blood, saliva, cerebral spinal fluid, pleural fluid, milk, lymph, sputum, semen, needle aspirates, and the like. Biological samples may be obtained from all of the various families of domestic animals, as well as feral or wild animals, including, but not limited to, such animals as ungulates, bear, fish, rodents, etc. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention. The term “admixture” refers to the phenomenon of gene flow between populations resulting from migration. Admixture can create linkage disequilibrium (LD).

“Solid support”, “support”, and “solid phase support” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. Microarrays usually comprise at least one planar solid phase support, such as a glass microscope slide. See U.S. Pat. No. 5,744,305 for exemplary substrates.

“Specific” or “specificity” in reference to the binding of one molecule to another molecule, such as a labeled target sequence for a probe, means the recognition, contact, and formation of a stable complex between the two molecules, together with substantially less recognition, contact, or complex formation of that molecule with other molecules. In one aspect, “specific” in reference to the binding of a first molecule to a second molecule means that to the extent the first molecule recognizes and forms a complex with another molecules in a reaction or sample, it forms the largest number of the complexes with the second molecule. Preferably, this largest number is at least fifty percent. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak non-covalent chemical interactions, such as Van der Waal forces, hydrogen bonding, base-stacking interactions, ionic and hydrophobic interactions, and the like, dominate the interaction of the molecules.

“Tm” is used in reference to “melting temperature.” Melting temperature is the temperature at which a population of double-stranded nucleic acid molecules becomes half dissociated into single strands. Several equations for calculating the Tm of nucleic acids are well known in the art. As indicated by standard references, a simple estimate of the Tm value may be calculated by the equation. Tm=81.5+0.41 (% G+C), when a nucleic acid is in aqueous solution at 1 M NaCl (see e.g., Anderson and Young, Quantitative Filter Hybridization, in Nucleic Acid Hybridization (1985). Other references (e.g., Allawi, H. T. & SantaLucia, J., Jr., Biochemistry 36, 10581-94 (1997)) include alternative methods of computation which take structural and environmental, as well as sequence characteristics into account for the calculation of Tm.

### Methods for Genotyping Polymorphisms

The disclosed methods are directed to novel methods of detecting variation in nucleic acid sequences. Forms of variation that may be detected include, for example, genetic variation, epigenetic variation, and variation at the level of gene expression. Types of genetic variation may include, for example, polymorphism, mutation, genetic copy number variation, including amplification and deletion of genetic regions and genomic rearrangements. Epigenetic variations that may be analyzed include, for example, methylation status of positions or regions, such as promoter regions. Gene expression variation may include, for example, changes in splicing pattern and changes in the level of a transcript.

In many aspects the methods are based upon the work previously described in U.S. Pat. No. 6,858,412. In one aspect a single color assay is used and each extension reaction is hybridized to a different array. Four separate arrays are used—one for each nucleotide (A, C, G, and T).

In another aspect the assay is a gap fill with two probes per polymorphism. Each probe is specific for one of the two alleles for a biallelic polymorphism. Two allele specific probes for each polymorphism. The probes are complementary to different alleles and have different tag sequences that are specific for the allele targeted by the probe. The assay may be a single color assay in a single tube and may include a gap filling step or simply a ligation step. This approach may be used, for example, for single base changes, insertions and deletions.

In another aspect two allele specific probes are used for each SNP. Both probes have the same tag sequence and the assay is preformed using differentially detectable labels for each of the different alleles. The assay is performed in parallel in two separate tubes. Each of the allele specific probes for a given SNP are in a separate reaction tube. The separate reaction tubes are distinguishably labeled and hybridized to the same array.

In another aspect the assay is performed as a 1 color, 1 array, using allele specific probes with different tags and gap fill.

In another aspect allele specific probes that have the same tag but different primers are used. The primers are used to differentially label the products so that each allele is labeled with a different color. This is a two color option with a single array.

Methods for multiplex characterization of genomic DNA using molecular inversion probe (MIP) methodology have been disclosed in U.S. Pat. Nos. 6,858,412, 5,866,337, and 5,871,921 and in Patent Pub. 20060281098, the entire disclosures of which are incorporated herein by reference for all purposes. In general, the methods disclosed herein are improvements to the methods of the U.S. Pat. No. 6,858,412. Other methods may also be used to genotype the polymorphisms in the selected set of polymorphisms, including, for example, the genotyping methods described in Steemers and Gunderson, Biotechnol. J. 2007, 2(1):41-9, Gunderson et al., Methods Enzymol 410:359-76 (2006), Gunderson et al., Genome Res., 8(11): 1142-53 (1998), Lovmar and Syvanen, Methods Mol. Med. 114:79-92 (2005), and Syvanen, Nat. Genet. 37:S5-S10 (2005). Such methods that may be used include single base extension (SBE), oligonucleotide ligation based assays, real time PCR methods, allele specific primer extension (ASPE), mass spectrometry, and allele specific hybridization methods, including array based methods, for example.

In one aspect, the assay is a single color assay and instead of using a different detectable label for each NTP a single label is used. Each NTP reaction may be performed in a separate tube and hybridized separately to a different array. In another aspect different tag sequences are used for different alleles. For example, two sets of MIPs may be used in separate reactions. For each allele, A or B, the A allele probe may be in a first set of MIPs and the B allele in a second, separate set of MIPs. The A and B allele probes for the SNP may vary only in the tag sequence. So, for each SNP there is a first MIP with tag 1 and a second MIP with tag 2, but the first and second MIPs may have the same target sequences. The extension reaction for the first and second MIP sets may be separate and each may include 2 of the 4 possible NTPs. At a point after extension and prior to hybridization to a single array the reactions may be mixed. For example, the first reaction may have A and C and the second G and T. The presence of allele A

In another aspect, fewer separate reactions steps are used. The reagents are added on fewer occasions. In preferred aspects the reactions take place in a single reaction tube or container. The reagents may be provided in a microtitre plate format, for example, in standard 96 or 384 well plates. These features may be combined to make the assay more automatable, provides for reduced reagent consumption and reduced sample consumption, allowing less sample to be used for a reaction, for example about 500 ng of DNA may be used per reaction to genotype 1,500 to 50,000 polymorphisms. In another aspect, Single color SAPE detection is used.

In some embodiments the methods allow for addition of reagents at fewer steps, for example, in one preferred embodiment reagents are added at only the following steps: annealing step, gap filling step, an amplification step, a digestion step, a hybridization step and a staining step (6 additions). This is an improvement over earlier methods where reagents were added at annealing, gap filling, dNTP, exonuclease, UNG, Amplification 1, Amplification 2, digest, hybridization and staining (10 additions). In the present embodiment reagents are added at no more than 6 separate steps during the entire reaction as compared to 10 reagent addition steps in earlier methods. In a preferred aspect the number of addition steps is decreased by combining reagents and adding them in a single reagent addition step instead of separate steps. In one aspect, at the gap filling reagent addition step the following reagents are added simultaneously: DNA ligase, DNA polymerase and exonuclease. The UNG and amplification reagents are added in a single addition. The reaction undergoes a single amplification step instead of two separate amplification steps. In addition, instead of using four separate tubes for the annealing through digestion-one for each of the four possible dNTPs, the reaction takes place in a single tube with all dNTPs included. The dNTPs may be combined with the MIP assay panel.

In one aspect the reagents for the gap fill reaction, the ligation reaction and the exonuclease reaction are added at the same time. The gap fill and ligation reaction occur more rapidly than the exonuclease reaction, allowing the specific circularization reaction to take place in the same reaction as the cleavage of uncircularized probes. In one aspect the gap fill/ligation/exonuclease reaction is at 37° C.

In one aspect the ligase is NAD dependent E. Coli DNA ligase and the DNA polymerase is Klenow (exo-).

In another aspect methods to reduce the amount of genomic DNA used for each sample are disclosed. It was discovered that lower amounts of DNA can be used without impacting the call rate and repeatability if the amount of probe is increased. For example, a call rate of about 95% with a repeatability of greater than 99.75% can be achieved using about 4000 ng genomic DNA and about 50 amol/probe assay panel. If the amount of genomic DNA is decreased to 280 ng DNA and the amount of probe is increased to about 500 amol/probe similar call rates (about 95%) and repeatability (greater than 99.75%) can be achieved. Table 1 shows the call rate and reproducibility achieved with varying amounts of DNA and varying amounts of probe.

TABLE 1

| | Call rate | | repeatability | |
|---|---|---|---|---|
| | 50 | 500 | 50 | 500 |
| | amol/probe | amol/probe | amol/probe | amol/probe |
| 4000 ng DNA | 94.89 | 94.54 | 99.75 | 99.61 |
| 1000 ng DNA | 94.6 | 95.45 | 99.8 | 99.9 |
| 500 ng DNA | 93.05 | 94.4 | 99.61 | 99.87 |
| 250 ng DNA | 90.5 | 92.58 | 99.16 | 99.73 |
| 150 ng DNA | 88.14 | 90.6 | 98.52 | 99.48 |

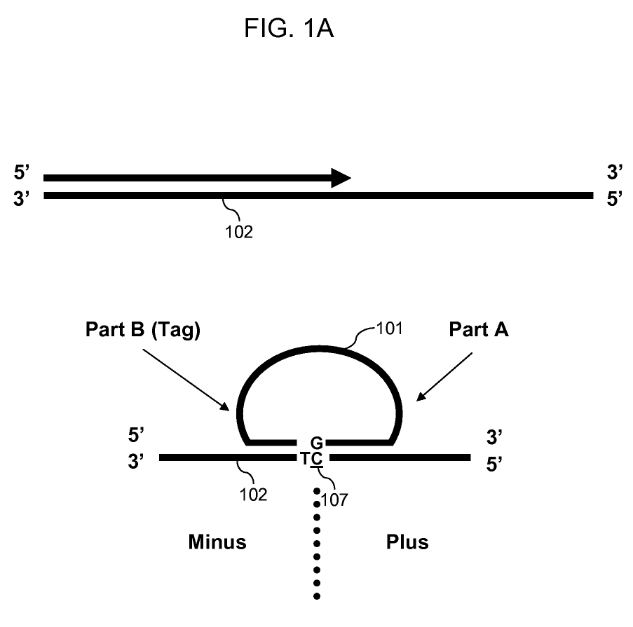

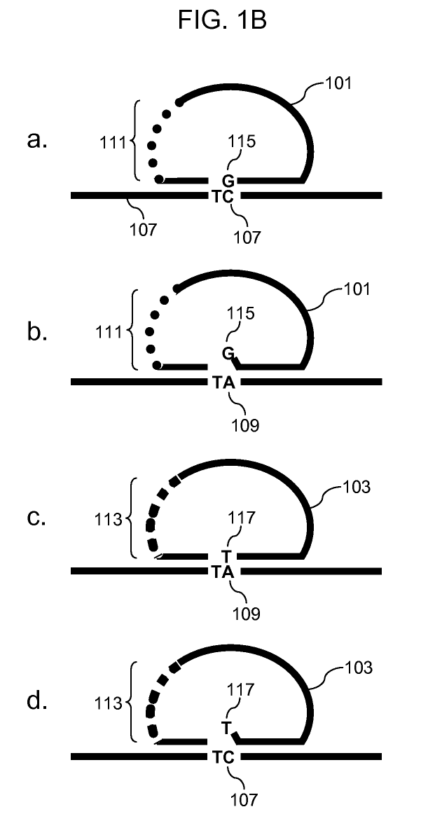

The general orientation of the target to the probe is shown in FIG. 1A. The target strand 102 is shown in the 3′ to 5′ orientation left to right. The single stranded probe 101 hybridizes to the target strand so that the 3′ end of the probe is on the left and the 5′ on the right. The region of the target that is 5′ of the interrogation position 107 (right of the dotted line) is referred to as the “plus” side and the region that is 3′ (left of the dotted line) is referred to as the “minus” side.

In one embodiment biallelic polymorphisms are interrogated by two probes, each probe being allele specific. The probes vary at the interrogation position and at the tag sequence. (FIG. 1B) The two alleles are either a C [107] or an A [109]. Each allele specific MIP has a different tag sequence [111 and 113] and can be detected at a different feature of an array of probes. For the example, shown in FIG. 1, there are two probes [101 and 103] for interrogation of the SNP and each having a different base [115 and 117] at the interrogation position. The probes differ at the tag sequences [111 and 113] and at the terminal base [115 and 117]. The probes are molecular inversion probes as described in U.S. Pat. No. 6,858,412 and include first and second priming sites, a cleavage site between the first and second priming site and optionally a second cleavage site for a restriction enzyme or other method of cleavage. Preferably the allele specific bases [115 and 117] are at the 5′ end of the probes and the 3′ end may be extended to close the gap between the ends prior to ligation of the ends to form a closed single stranded circular probe (double stranded in the region hybridized to the target). The 5′ and 3′ regions of the probes are complementary to regions in the target that flank the polymorphism. In some embodiments the target complementary regions are the same for both alleles of the polymorphism. When the polymorphism is an insertion or deletion the flanking regions of the probe may vary. The ends of the probes are extended if the complementary allele is present

In some embodiments there is a gap of at least one base between the ends of the MIP when hybridized to the target. The use of a gap filling reaction in combination with allele specific probes may be particularly useful when there are two SNPs within a few bases of one another. The probes may be designed to be allele specific for the first SNP and include the second SNP within the gap. With this approach the probe will be complementary independent of the allele present at the second SNP.

The length of the gap can vary, for example, it may be 1, 2, 3, 4 or 5 bases. The gap may be positioned for example, so that the SNP is at the 3′ end of the MIP, one base in from the 3′ end of the MIP, at the 5′ end of the MIP, or one base in from the 5′ end of the MIP.

Probes with a gap at the plus 1 position (see FIG. 1A) showed the best performance. Because genomic DNA is double stranded there are two possible plus 1 probe designs for any SNP and in some embodiments probes are designed to be plus 1 when possible. For example, if there is a wobble at −1 the opposite strand may be used. If a wobble exists 5′ of the SNP (+ direction) a multinucleotide gap may be used and if 3′ (− direction) the opposite strand may be targeted.

There are differences in efficiency depending on which base is included as the GapFill base or the Run-on base. Probes may be designed and target strand selected to optimize signal by selected a preferred run-on or gapfill base. Each of the four possible bases shows different average signal when it is the GapFill base or the Run-on base as follows: A: gapfill 87%, run-on 96%, C: gapfill 90%, run-on 74%,G: gapfill 85%, run-on 100%, T: gapfill 100%, run-on 80%. In some aspects, if there is a wobble near the polymorphism the gap can be designed to include the wobble.

In another embodiment the reaction volume hybridized to the array may be varied. Different volumes from a 60 μl assay containing about 2800 probes and interrogating about 1400 SNPs, were hybridized to an array and call rate and average signal were measured. The volumes tested were 0.5, 1, 2, 4, 8, 16, and 32 μl. The average signal intensity increased approximately proportionately as the volume increased but the call rates were similar for 0.5 to 8 μl (between 84 and 86%) but slightly lower for 16 and 32 μl (about 83.5 and 80.75% respectively).

Methods for whole genome amplification may be used to amplify a genomic sample if the sample is limiting, for example, multiple displacement amplification (MDA), methods disclosed in U.S. Patent Pub. No. 20030143599 and 20030040620, or any other non-specific amplification method. REPLI-g kits for performing MDA are available from QIAGEN, Inc. If possible, such pre-amplification steps should be avoided because some sequences may amplify poorly or not at all while others may amplify with better than average efficiency, resulting in an amplified sample that is not completely representative of the starting sample. This is particularly true if the subsequent analysis is directed at a quantitative rather than qualitative question, for example, genomic copy number. Pre-amplification can also be problematic if the starting sample is of poor quality, for example, FFPE samples which may be degraded to some extent.

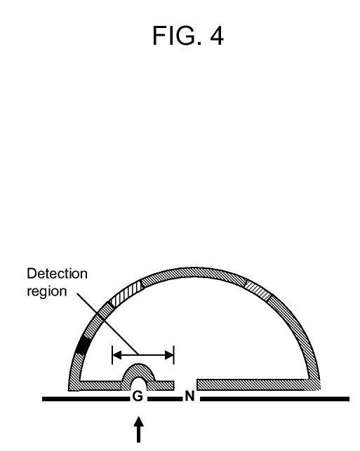

FIG. 4 shows a schematic of methods to use the precircle probe to measure the genotype of two polymorphisms that are close together. When hybridization based assays are used to genotype polymorphisms that are closely spaced within a genetic regions one of the polymorphisms may interfere with the detection of the second polymorphism. A second polymorphism that is near a first polymorphism being interrogated and within the probe being used to interrogate the first polymorphism is referred to herein as a “wobble”. The wobble may be a SNP, a variant or an indel. The wobble can interfere with genotyping of the first polymorphism by destabilizing the probe and affecting the efficiency of the probe annealing reaction. In some aspects a base analogue with altered specificity may be used at the probe position corresponding to the wobble, for example, inosine. This allows for hybridization regardless of the sequence at the secondary site.

In another aspect, two probes may be used. A first probe may be perfectly complementary to the region immediately adjacent to the interrogation position and include a first allele of the wobble, while the second probe may be identical to the first but contain a second allele of the wobble. The signals from the two probes are combined to give the genotype call for the interrogation position.

In another aspect methods for genotyping loci that have close homologs and sequence related pseudogenes present in the genome, are disclosed. Pseudogenes can complicate the analysis of related sequences and can cause homozygous calls to appear as heterozygous calls or vice versa. To overcome this, targets that contain pseudogenes may be subjected to a multiplex PCR amplification using primers that are specific to the desired gene. Increasing the concentration of the target section of the genome relative to the undesired but closely related regions increases the signal from the target and facilitates cluster separation.

In a preferred aspect, where a panel of SNPs is to be interrogated in a multiplex assay, such as the MIP assay with the DMET panel a subset of the loci may be amplified in a multiplex PCR using target specific primers prior to the MIP assay. In the DMET panel (shown in Tables 2 and 3), there are 31 loci that may be subjected to a single multiplex PCR (mPCR) amplification to generate 14 PCR amplicons. For example, CYP2D6 may be amplified as six amplicons covering eight exons. In one aspect, about 50 ng of genomic DNA may be amplified in the mPCR using the Qiagen Multiplex PCR kit. The amplified DNA may then be diluted and added back to the matched genomic DNA prior to or concurrent with the annealing stage. In a preferred aspect, the loci shown in Table 4 are subjected to mPCR in the DMET assay.

The columns of Table 3 are as follows: Affymetrix ID, External ID (for example rs#), Chromosome number, base pair position using NCBI build 35, gene name, alleles, and probe homology sequence with “N” at polymorphic position.

Genetic variation is an important determinant in the ability of different individuals to metabolize drugs. Studies of an individual's genetic background may be used to target medications and to adjust treatment dose depending on the polymorphisms present in the individual. The DMET panel facilitates such testing by providing a single assay that analyzes more than 1,200 polymorphisms in a set of genes that may play a role in drug metabolism. Related products that are available include the Roche Diagnostics AmpliChip CYP450 Test and the Third Wave Technologies Invader UGT1A1 test for identification of patients with the UGT1A1*28 allele.

In addition to analyzing a larger number of SNPs, the DMET panel is also a flexible platform. Additional polymorphisms can be added without modifying the underlying assay conditions or the detection method. The panel also interrogates many different genes simultaneously, facilitating the detection of particular combinations of alleles in different genes that may be involved in the metabolism of a new drug.

Table 5 shows a list of sequences that include SNPs that may be included in a panel for genotyping human patients for determining drug response and dosing. For each SNP an identifier is given, for example, an rs# followed by the sequence of one strand in a 5′ to 3′ orientation (left to right) with the polymorphic position in the center indicated in brackets with the two possible alleles separated by a /, for example, [C/G] indicates that the A and B alleles are C or G for the SNP. The polymorphic position is flanked by 50 bases upstream and downstream.

### EXAMPLES

### Example 1

The following probe designs were tested: 1 nt gap at minus 2, 1 nt gap at minus 1, 1 nt gap at 0, 1 nt gap at plus 1, 1 nt gap at plus 2, 2 nt gap at minus 1 and minus 2, 2 nt gap at plus 1 and plus 2, nick between minus 1 and minus 2, nick between minus 1 and 0, nick between 0 and plus 1, nick between plus 1 and plus 2 and 5 base pair gap (missing minus 1, minus 2, 0, plus 1 and plus 2. For a 1 nt gap the probes with a gap at plus 1 performed best followed by minus 1, plus 2 then minus 2.

### CONCLUSION

It is to be understood that the above description is intended to be illustrative and not restrictive. Many variations of the invention will be apparent to those of skill in the art upon reviewing the above description. The scope of the invention should be determined with reference to the appended claims, along with the full scope of equivalents to which such claims are entitled. All cited references, including patent and non-patent literature, are incorporated herein by reference in their entireties for all purposes.

Lengthy table referenced here
US20090131268A1-20090521-T00001
Please refer to the end of the specification for access instructions.

Lengthy table referenced here
US20090131268A1-20090521-T00002
Please refer to the end of the specification for access instructions.

Lengthy table referenced here
US20090131268A1-20090521-T00003
Please refer to the end of the specification for access instructions.

Lengthy table referenced here
US20090131268A1-20090521-T00004
Please refer to the end of the specification for access instructions.

LENGTHY TABLES
The patent application contains a lengthy table section. A copy of the table is available in electronic form from the USPTO web site (http://seqdata.uspto.gov/?pageRequest=docDetail&DocID=US20090131268A1). An electronic copy of the table will also be available from the USPTO upon request and payment of the fee set forth in 37 CFR 1.19(b)(3).

1. A method of determining a patient's risk for an adverse drug response comprising:
(a) genotyping the patient for each of the SNPs in Table 6 to obtain the patient's genotype for each of the SNPs in Table 6;
(b) comparing the genotype of the patient at each of a plurality of the SNPs in Table 5 to a table of genotypes for each of the SNPs listed in Table 6, wherein each of the genotypes in the table of genotypes is associated with a risk for an adverse drug response to one or more drugs selected from a plurality of drugs; and
(c) determining the patient's risk for an adverse drug response to a drug from said plurality of drugs.

2. The method of claim 1 wherein said genotyping is by a method comprising: hybridizing a padlock probe to a DNA sample from said patient; ligating the ends of the padlock probe in a sequence dependent manner to form a closed circle probe; amplifying the closed circle probe to obtain an amplification product and detecting the presence of the amplification product.

3. The method of claim 2 wherein the step of detecting comprises hybridization to an array of probes that are complementary to tag sequences that are present in the padlock probe and wherein padlock probes for different SNPs comprise different specific tag sequences that can be used to identify the individual SNPs.

4. The method of claims 1, 2 or 3 further comprising (i) genotyping the patent for at least 100 SNPs in Table 5 and (ii) repeating steps (b) and (c) for the at least 100 SNPs in Table 5 that were genotyped in step (i).
